(19) United States
(12) Patent Application Publication
(10) Pub. No.: US 2004/0113470 A1
(43) Pub. Date: Jun. 17, 2004

(54) Prostate protecting bicycle seat

(76) Inventor: Kevin S. Tobias, Sussex, NJ (US)

Correspondence Address: Paul Gauer, 347 Franklin St, Bloomfield, NJ, 07003, US

(21) Appl. No.: 10/317,286

(22) Filed: Dec. 13, 2002

(51) Int. Cl. B62J 1/00

(52) U.S. Cl. 297/202

(57) ABSTRACT

The prostate protecting bicycle seat (10) having a seat (12) which has a vertically or vertically angled positioned seat left lower (12LL) securely connected at a top distal end to a front distal end of a horizontally positioned seat left upper (12LU) securely connected at a rear distal end to a left distal end of a U-Shaped seat back (12B) connected at a right distal end to a rear distal end of a horizontally positioned seat right upper (12RU) connected to at a front distal end to a top distal end of a vertically or vertically angled positioned seat right lower (12RL) forming a seat opening (12B) between the seat right (12RU, 12RL) and the seat left (12LU, 12LL).

### BACKGROUND OF THE INVENTION

1. Field of the Invention

The present invention relates to a bicycle seat. More particularly, the present invention relates to a U-Shaped bicycle seat to prevent pressure from being exherted on a user's prostate.

2. Description of the Prior Art

Numerous innovations for a prostate protecting bicycle seat have been provided in the prior art that are described as follows. Even though these innovations may be suitable for the specific individual purposes to which they address, they differ from the present invention as hereinafter contrasted.

In U.S. Pat. No. 6,302,480, invented by, Hall, titled, Bicycle seat with weight distributed for avoidance of vascular injury, a bicycle seat in which the rider's weight is distributed away from the center of the rider's body toward the buttocks and legs. Front and rear central indentations that are formed in the seat to reduce the longitudinal length in the central portion of the bicycle seat and minimize contact between the bicycle seat and the central seating area of a rider's body. An extended seating surface extends laterally outward from the longitudinal axis of the bicycle to provide a more comfortable seating area upon which the buttocks of the rider can more fully support the rider's body weight. An optional central cavity extends longitudinally along the central portion of the upper surface of the bicycle seat such that the extended seating surface is separated into separate left and right segments, each segment supporting one of the rider's buttocks. The central cavity is formed with a width and depth sufficient to minimize or eliminate contact between the central seating area of a rider's body and the upper surface of the bicycle seat such that the bicycle seat does not interfere with or injure the circulatory system of the rider in the central seating area of the rider's body. Optional left front and right front sloped surfaces extend forward and downward from the extended seating surface such that the left and right legs of the rider, respectively, are supported as the rider pedals. An optional adjustable seating surface provides additional comfort to the rider.

In U.S. Pat. No. 6,142,562, invented by, Varan, titled, Bicycle seat, a bicycle seat is provided including a pair of uppwardly divergent, opposite side support arms having lower ends pivotally mounted from a bicycle frame appreciably below the usual bicycle seat mounting structure of the bicycle frame and upper ends swingable toward and away from each other. The upper ends of the support arms include generally horizontal weight support members having longitudinal mid-portions pivotally supported from the arm upper ends for oscillation about generally horizontal transverse axes and the arms, including their pivotal mounting, are mounted from the bicycle frame for limited oscillation about an upstanding axis, angular displacement about the upstanding axis, in both directions from a center position thereof, being progressively yieldingly resisted.

In U.S. Pat. No. 6,068,333, invented by, Dixon, titled, Dual support unit bicycle seat, an improved bicycle seat designed to prevent damage to the rider's health by transferring the riders weight from the sub scrotal area to the sit bones. The bicycle seat includes a single piece seat rail, a forward pad, a fastener for securing the forward pad to the seat rail, a combination of fasteners for securing the dual support units to the seat rail, and dual support units each having a seat platform and a seat pad. The dual support units have a plurality of adjustments allowing them to be independently positioned by moving them horizontally inwards and outwards and horizontally forwards and backwards.

In U.S. Pat. No. 5,988,740, invented by, Caraballo, titled, Bicycle seat, a seat assembly that includes two symmetrical elongated seat sections having each an upperside, an underside with two ends. One of the ends of each of the seat sections are pivotally mounted to a pivoting axle that is transversally disposed. The seat sections are adjacent to each other. A reciprocating mechanism is mounted to the seat assembly at a distance from the underside and causes the sections to move in reciprocal opposite directions. Theprojectionofauser's spine is substantially aligned with pivoting axle. When a user applies his/her weight on one of the pedals, some of this weight is exerted on the distal end which is turn causes the other section to lift the other leg, thus alleviating a user's fatigue.

In U.S. Pat. No. 5,988,739, invented by, Dodge, et al., titled, Anatomically correct bicycle seat, an anatomically correct bicycle seat, which includes a platform to receive the buttocks of a bicycle rider and a support mechanism for the platform in order to permit the anatomically correct seat to be mounted on a bicycle, relieves on blood vessels of a bicycle rider.

The above patented inventions differ from the present invention because they fail to describe or claim at least one combination of the features depicted in the present invention.

Numerous innovations for a prostate protecting bicycle seat have been provided in the prior art that are adapted to be used. Even though these innovations may be suitable for the specific individual purposes to which they address, they would not be suitable for the purposes of the present invention as heretofore described.

### SUMMARY OF THE INVENTION

The present invention relates to a bicycle scat. More particularly, the present invention relates to a U-Shaped bicycle seat to prevent pressure from being exherted on a user's prostate.

The types of problems encountered in the prior art are bicycle seats put pressure on a user's prostate making riding a bicycle uncomfortable

In the prior art, unsuccessful attempts to solve this problem were attempted namely: seats with circular or oval openings. However, the problem was solved by the present invention because the present invention is a horse-shoe shapped seat optionally having flexible vertically positioned lower members for support.

Innovations within the prior art are rapidly being exploited in the field of ergodynamically engineering bicycle seats.

The present invention went contrary to the teaching of the art which describes and claims bicycle seats with closed openings.

The present invention solved a long felt need for an open U-Shaped bicycle seat which can fit all users.

A synergistic effect was produced utilizing the present invention due to the following facts and results from experimentation: lower incident of prostate enlargement.

Accordingly, it is an object of the present invention to provide a prostate protecting bicycle seat having a U-Shaped seat, sanction, and post.

More particularly, it is an object of the present invention to provide U-Shaped seat having a seat opening, seat back, seat right upper, seat right lower, seat left upper, and seat left lower.

In keeping with these objects, and with others which will become apparent hereinafter, one feature of the present invention resides, briefly stated, in the sanction having a sanction holder, right front sanction, right rear sanction, left front sanction, and left rear sanction.

The novel features which are considered characteristic for the invention are set forth in the appended claims. The invention itself, however, both as to its construction and its method of operation, together with additional objects and advantages thereof, will be best understood from the following description of the specific embodiments when read and understood in connection with the accompanying drawings.

### List of Reference Numerals Utilized in the Drawings

10—prostate protecting bicycle seat (10)

12—seat (12)

12A—seat opening (12B)

12B—seat back (12B)

12RU—seat right upper (12RU)

12RL—seat right lower (12RL)

12LU—seat left upper (12LU)

12LL—seat left lower (12LL)

14—sanction (14)

14A—sanction holder (14A)

14RF—right front sanction (14RF)

14RR—right rear sanction (14RR)

14LF—left front sanction (14LF)

14LR—left rear sanction (14LR)

16—post (16)

18—bicycle (18)

18A—bicycle frame (18A)

20—user (20)

20A—user's prostate (20A)

### BRIEF DESCRIPTION OF THE DRAWINGS

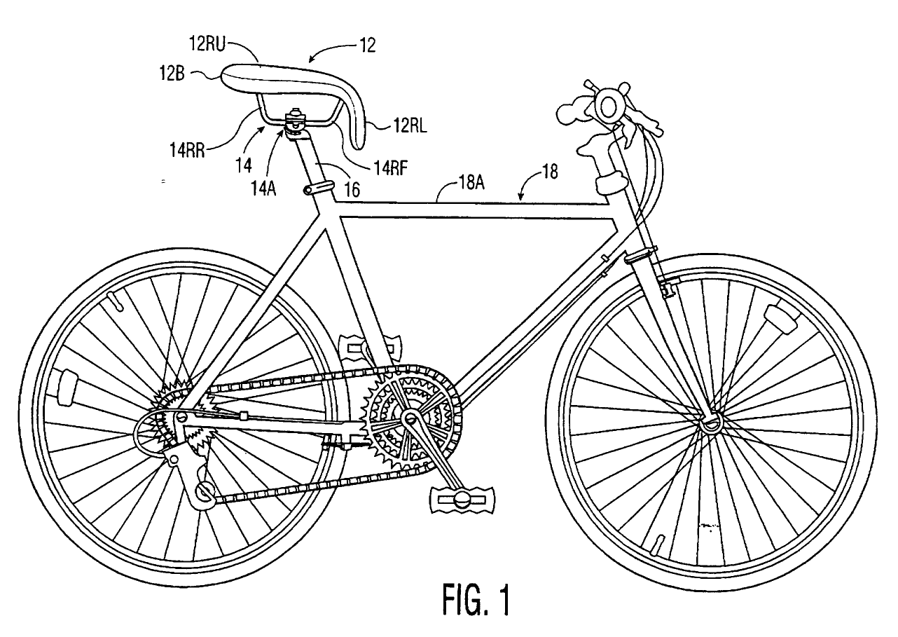

FIG. 1 is a right side view of a prostate protecting bicycle seat (10) mounted on a bicycle frame (18A) of a bicycle (18).

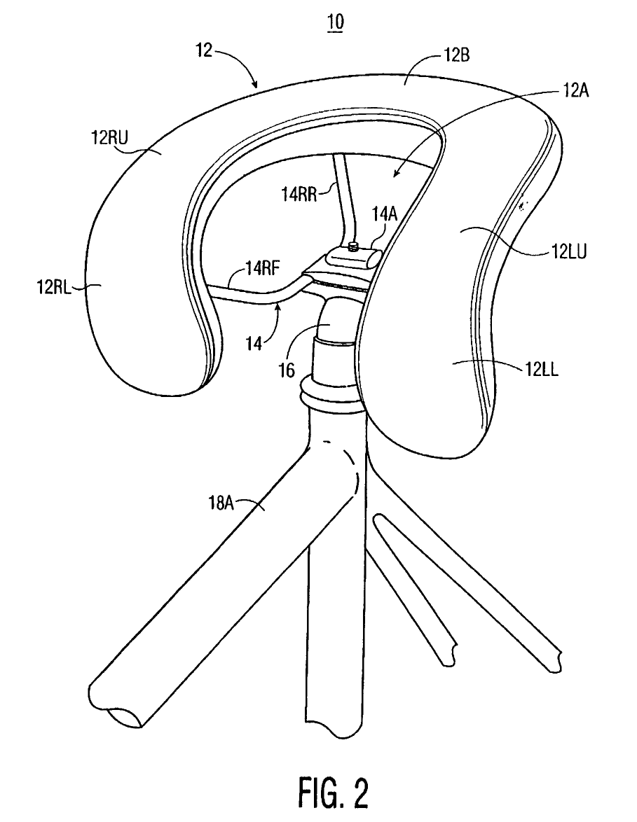

FIG. 2 is a left top perspective view of a prostate protecting bicycle seat (10) mounted on a bicycle frame (18A).

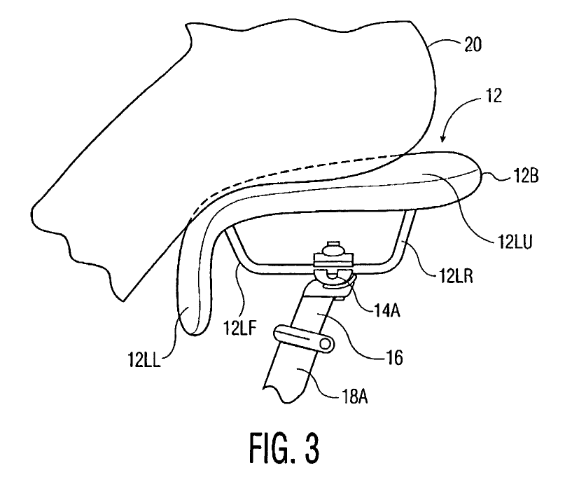

FIG. 3 is a left side view of a prostate protecting bicycle seat (10) mounted on a bicycle frame (18A) having a user (20) positioned thereon.

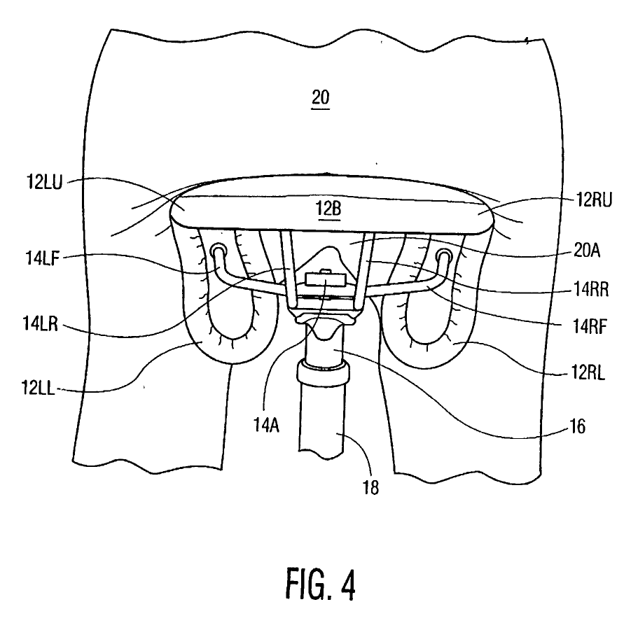

FIG. 4 is a rear view of a prostate protecting bicycle seat (10) mounted on a bicycle frame (18A) having a user (20) positioned thereon exhibiting the user's prostate (20A) positioned within the seat opening (12B).

### DESCRIPTION OF THE PREFERRED EMBODIMENT

Firstly, referring to FIG. 1 which is a right side view of a prostate protecting bicycle seat (10) mounted on a bicycle frame (18A) of a bicycle (18) and FIG. 3 which is a left side view of a prostate protecting bicycle seat (10) mounted on a bicycle frame (18A) having a user (20) positioned thereon. The prostate protecting bicycle seat (10) comprises a seat (12) which comprises a vertically or vertically angled positioned seat left lower (12LL) securely connected at a top distal end to a front distal end of a horizontally positioned seat left upper (12LU) securely connected at a rear distal end to a left distal end of a U-Shaped seat back (12B) connected at a right distal end to a rear distal end of a horizontally positioned seat right upper (12RU) connected to at a front distal end to a top distal end of a vertically or vertically angled positioned seat right lower (12RL) forming a seat opening (12B) between the seat right (12RU, 12RL) and the seat left (12LU, 12LL). (Refer to FIG. 2 and FIG. 4)

The seat (12) is optionally manufactured from a non-flexible base. The seat (12) is optionally manufactured from a non-flexible base having a cushion securely affixed thereon. The seat (12) is optionally manufactured from a flexible base. The seat (12) is optionally manufactured from a hard base having a cushion securely affixed thereon. The seat back (12B) and seat right upper (12RU) and seat left upper (12LU) are preferably manufactured from a non-flexible base and the seat right lower (12RL) and the seat left lower (12LL) are preferably manufactured from a flexible base. The seat (12) is preferably manufactured from a hard base having a cushion securely affixed thereon.

Referring to FIG. 2 which is a left top perspective view of a prostate protecting bicycle seat (10) mounted on a bicycle frame (18A) and FIG. 4 which is a rear view of a prostate protecting bicycle seat (10) mounted on a bicycle frame (18A) having a user (20) positioned thereon exhibiting the user's prostate (20A) positioned within the seat opening (12B). The prostate protecting bicycle seat (10) further comprises a top of a sanction (14) is securely affixed to a bottom of the seat (12). The sanction (14) comprises a right front sanction (14RF) securely attached at a top distal end to a bottom of the seat right lower (12RL). The sanction (14) further comprises a right rear sanction (14RR) securely attached at a top distal end to a bottom of the seat right upper (12RU) or seat back (12B). The sanction (14) further comprises a left rear sanction (14LR) securely attached at a top distal end to a bottom of the seat left upper (12LU) or seat back (12B), and the sanction (14) further comprises a left front sanction (14LF) securely attached at a top distal end to a bottom of the seat left lower (12LL). The sanction (14) further comprises a sanction holder (14A) securely attached to lower distal ends of the right front sanction (14RF) and the right rear sanction (14RR) and the left front sanction (14LF) and the left rear sanction (14LR).

The prostate protecting bicycle seat (10) comprises a top distal end of a post (16) is securely fastened to a bottom of the sanction (14).

It will be understood that each of the elements described above, or two or more together, may also find a useful application in other types of constructions differing from the type described above.

While the invention has been illustrated and described as embodied in a prostate protecting bicycle seat, it is not intended to be limited to the details shown, since it will be understood that various omissions, modifications, substitutions and changes in the forms and details of the device illustrated and in its operation can be made by those skilled in the art without departing in any way from the spirit of the 6 present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this 11 invention.

What is claimed as new and desired to be protected by Letters Patent is set forth in the appended claims.

What is claimed is:

1. A prostate protecting bicycle seat (10) comprising:
A) a seat (12) which comprises a vertically or vertically angled positioned seat left lower (12LL) securely connected at a top distal end to a front distal end of a horizontally positioned seat left upper (12LU) securely connected at a rear distal end to a left distal end of a U-Shaped seat back (12B) connected at a right distal end to a rear distal end of a horizontally positioned seat right upper (12RU) connected to at a front distal end to a top distal end of a vertically or vertically angled positioned seat right lower (12RL) forming a seat opening (12B) between the seat right (12RU, 12RL) and the seat left (12LU, 12LL),
B) a top of a sanction (14) is securely affixed to a bottom of the seat (12), and
C) a top distal end of a post (16) is securely fastened to a bottom of the sanction (14).

2. The prostate protecting bicycle seat (10) as described in claim 1, wherein the seat (12) is manufactured from a non-flexible base.

3. The prostate protecting bicycle seat (10) as described in claim 2, wherein the seat (12) is manufactured from a non-flexible base having a cushion securely affixed thereon.

4. The prostate protecting bicycle seat (10) as described in claim 1, wherein the seat (12) is manufactured from a flexible base.

5. The prostate protecting bicycle seat (10) as described in claim 4, wherein the seat (12) is manufactured from a hard base having a cushion securely affixed thereon.

6. The prostate protecting bicycle seat (10) as described in claim 1, wherein the seat back (12B) and seat right upper (12RU) and seat left upper (12LU) are manufactured from a non-flexible base and the seat right lower (12RL) and the seat left lower (12LL) are manufactured from a flexible base.

7. The prostate protecting bicycle seat (10) as described in claim 6, wherein the seat (12) is manufactured from a hard base having a cushion securely affixed thereon.

8. The prostate protecting bicycle seat (10) as described in claim 1, wherein the sanction (14) comprises a right front sanction (14RF) securely attached at a top distal end to a bottom of the seat right lower (12RL), the sanction (14) further comprises a right rear sanction (14RR) securely attached at a top distal end to a bottom of the seat right upper (12RU) or seat back (12B), the sanction (14) further comprises a left rear sanction (14LR) securely attached at a top distal end to a bottom of the seat left upper (12LU) or seat back (12B), and the sanction (14) further comprises a left front sanction (14LF) securely attached at a top distal end to a bottom of the seat left lower (12LL).

9. The prostate protecting bicycle seat (10) as described in claim 2, wherein the sanction (14) further comprises a sanction holder (14A) securely attached to lower distal ends of the right front sanction (14RF) and the right rear sanction (14RR) and the left front sanction (14LF) and the left rear sanction (14LR).
